(19) United States
(12) Patent Application Publication
(10) Pub. No.: US 2017/0329808 A1
(43) Pub. Date: Nov. 16, 2017

(54) SYSTEM AND METHOD FOR A MULTI-SENSOR NETWORK INTERFACE FOR REAL-TIME DATA HISTORIAN

(71) Applicant: Neotek Energy, Inc., Plano, TX (US)

(72) Inventors: Lawrence M. Lachman, Plano, TX (US); Ronald E. McDaniel, Fort Worth, TX (US); Douglas B. Weiner, Plano, TX (US)

(21) Appl. No.: 15/152,913

(22) Filed: May 12, 2016

(51) Int. Cl. G06F 17/30; G06F 17/24; E21B 47/12; H04L 29/08

(52) U.S. Cl. CPC G06F 17/30312; H04L 67/12; G06F 17/30557; E21B 47/122; G06F 17/248; E21B 47/124; G06F 17/30516

(57) ABSTRACT

A multi-sensor network interface includes at least one processor. The at least one processor is configured to receive a commission notification message from each of a plurality of data sources, each data source associated with at least one sensor, in response to receiving the commission notification message from each data source, provision each data source for reception of data from the data source, receive data from each data source, and store the received data in a data historian. The received data from a first one of the data sources includes at least one different data type than the received data from a second one of the data sources.

### TECHNICAL FIELD

This disclosure is generally directed to a system and method for a multi-sensor network interface for a real-time data historian.

### BACKGROUND

Real-time databases are used to monitor and control real-world activities such as telecommunication systems, routers and network management systems, telephone switching systems, control systems, automatic tracking and object positioning, engine control in automobiles, multimedia servers for real-time streaming, e-commerce and e-business, stock market and stock trading financial services programs, credit card transactions, web-based data services, and process control systems. Such real-time databases often include an interface to provide access to accumulate data, a data historian to store and compress the data, and connectivity into business information systems.

### SUMMARY

This disclosure provides a system and method for a multi-sensor network interface for a real-time data historian.

Embodiments of this disclosure optimize drilling or production operations by providing for faster deployment of devices in the field, fewer errors during commissioning, built-in analytics, collection of high speed aggregate data, the ability to control and configure the data source, robust and reliable performance, and reduced maintenance.

The disclosed embodiments provide an interface that collects geographically diverse measurement data, analyzes the data, and stores the data in a data historian. The interface is flexible enough to accommodate a variety of hardware architectures, data networks, and data types, and can automatically provision the sensors for data collection. The act of provisioning each data source can include, but is not limited to, creating assets that uniquely identify the data source and its location, data storage points in the data historian, and metadata for monitoring the system for events, error conditions, and alarms. The data source is treated as the system of record. To simplify the provisioning of each field device, the interface reads provisioning data sent from each field device when commissioned, and automatically generates and maintains assets and metadata, all without human intervention. In addition, the interface provides an out-of-band channel (i.e., a channel that is separate from the main data stream) to send commands to, and receive responses from, the field devices for a variety of purposes.

In a first embodiment, a method performed by at least one processing device is provided. The method includes receiving a commission notification message from each of a plurality of data sources, each data source associated with at least one sensor. The method also includes, in response to receiving the commission notification message from each data source, provisioning each data source for reception of data from the data source. The method further includes receiving data from each data source. In addition, the method includes storing the received data in a data historian. The received data from a first one of the data sources includes at least one different data type than the received data from a second one of the data sources.

In a second embodiment, a multi-sensor network interface is provided that includes at least one processor. The at least one processor is configured to receive a commission notification message from each of a plurality of data sources, each data source associated with at least one sensor; in response to receiving the commission notification message from each data source, provision each data source for reception of data from the data source; receive data from each data source; and store the received data in a data historian. The received data from a first one of the data sources includes at least one different data type than the received data from a second one of the data sources.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example asset hierarchy that uniquely identifies a data source according to this disclosure;

FIG. 2 illustrates an architecture diagram of an example system that uses a multi-sensor network interface according to this disclosure;

FIG. 3 illustrates three example measurement templates that may be used by one or more of the data sources and the interface of FIG. 2 according to this disclosure;

FIG. 4 illustrates additional details of a multi-sensor network interface according to this disclosure;

FIG. 5 illustrates an example computing device for use in the system of FIG. 2 according to this disclosure; and

FIG. 6 illustrates an example method for a multi-sensor network interface according to this disclosure.

### DETAILED DESCRIPTION

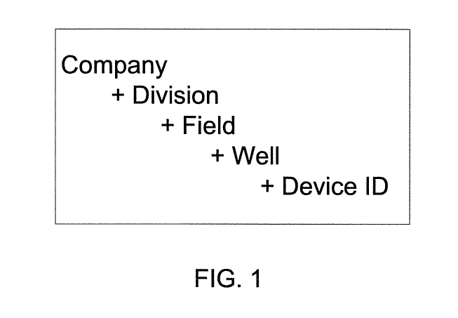

FIGS. 1 through 6, discussed below, and the various embodiments used to describe the principles of the present disclosure in this patent document are by way of illustration only and should not be construed in any way to limit the scope of this disclosure. Those skilled in the art will understand that the principles of the present disclosure may be implemented in any type of suitably arranged device or system.

Real-time databases are used to monitor and control real-world activities such as telecommunication systems, routers and network management systems, telephone switching systems, control systems, automatic tracking and object positioning, engine control in automobiles, multimedia servers for real-time streaming, e-commerce and e-business, stock market and stock trading financial services programs, credit card transactions, web-based data services, and process control systems. Examples of real-time databases include MDUS by SAP and TELVENT by SCHNEIDER ELECTRIC in electric meter reading, the RTAP platform by INDUSTRIAL DEFENDER for use in Supervisory Control And Data Acquisition (SCADA) systems, and the PI SYSTEM by OSISOFT, INC., to provide monitoring of programmable logic controllers (PLC).

Such real-time databases often include an interface to provide access to accumulate data, a data historian to store and compress the data, and connectivity into business information systems (or business analytics to enable insight and understanding of the gathered data). In each of these instances, the interfaces to the databases are unique to the PLC, meter, or other data source. For example, OSISOFT provides over 450 PI interfaces to provide connectivity to most distributed control systems, SCADA systems, and PLCs.

In particular for the PI SYSTEM, but similarly for other real time databases, data moves from a data source, through an interface, and then into the PI Data Archive Server, a data historian. The interface reads a single point of measurement from the data source, assigns a timestamp, applies a method of filtering, and passes the value to the PI Data Archive Server where it is stored in a data archive. The interface usually takes the form of a MICROSOFT WINDOWS service running on its own computer hardware, and not on the PI Data Archive Server's hardware. A PI Tag is the single storage point on the PI Data Archive Server. PI tags are created separate from a PI interface.

There are two classes of problems with these types of interfaces. A first class of problems relates to ease of configurability. Such interfaces are preconfigured with scan frequencies, which instruct the interface how often to poll field devices (in seconds) for all of their data measurements (i.e., the scan frequency cannot be unique per field device). A user must spend a great deal of time preconfiguring data points (i.e., data measurements from a specific sensor), the data interval to poll the field device for data, and how to connect to the data source. Every time a user changes something in the data source, it is extremely complicated and time consuming to reconfigure the interface. Consequently, it is challenging to configure an interface, as each of the many interfaces behaves differently. Also, it can be time consuming to build an asset model which has no relationship to the interface and how the interface collects data.

A second class of problems relates to flexibility in collecting data. Generally, in a PI interface, data points must be the same across all field devices to which the PI interface is connected. Because of the limitations of collecting contiguous data, PI interfaces are unable to collect large amounts of high speed data. Also, because data sources must be preconfigured and known a priori by the PI interface, PI interfaces are severely limited in their ability to collect data from many new systems.

To address these and other issues, embodiments of this disclosure provide a system and method for a multi-sensor network interface for a real-time data historian. The disclosed embodiments provide a new system and methodology for collecting high speed, real-time data from data sources over the Internet or other network, for interfacing with a real-time database.

The disclosed methodology is capable of:
Automatically provisioning data sources for data collection.
Automatically discovering assets and measurement data per field device.
Automatically creating the assets that uniquely identify the data source.
Automatically creating the metadata for monitoring the data source for events, error conditions, and alarms.
Treating the data source as the system of record.
Receiving geographically diverse data in an asset-centric way, and storing the time series data in a data historian, where the variety of heterogeneous data types can vary from field device to field device, as can the rate at which the data source sends the data.
Receiving and parsing a network message packet containing aggregate data based on assets (not individual data streams), where each packet can contain multiple, contiguous data blocks, and each data block corresponds to a single sample containing multiple data points, treated as a single entity of contiguous data.
Sending and receiving multi-packet messages, where the packets are disassembled from and assembled into contiguous data representing files.
Receiving and parsing a file containing bulk data from the data source.
Providing an out-of-band channel (i.e., a channel that is separate from the main data stream) that allows client programs to send operational commands, and configuration and firmware updates to the data source.
Analyzing data, collecting event data types, monitoring these events, and generating corresponding alerts, thereby reducing unit downtime and equipment damage, and increasing safety.

Some of the disclosed embodiments relate generally to chemical measurement and multi-sensor information systems, and more particularly, to tools for monitoring and managing individual measurements of subsurface chemical flows, and storing related data in a data historian. In some embodiments, a high resolution, multi-sensor information system directly detects and measures specific chemicals at the molecular level for collecting data from gas and oil production streams. Of course, this disclosure is not limited to chemical measurement in gas and oil production; the disclosed embodiments are also applicable in other environments and technologies. Multi-sensor information systems may be geographically dispersed, such that each system may be located at a different geographical site, and connected over long distance communication links, such as cellular networks. The multi-sensor information system is referenced herein as the data source.

As used herein, the term “data historian” refers to one or more devices or systems for recording and managing well production data using a time series database. Applications such as the PI SYSTEM provided by OSISOFT, INC., and INDUSTRIAL DEFENDER's RTAP platform, can be part of a system solution where a data historian is used for storing data transmitted by the multi-sensor systems or other sources. However, it is understood that other data aggregation systems may be used and this disclosure is not limited to the PI system. The system architecture assumes one or more multi-sensor network interfaces that consolidate and write the data to one or more historians. A series of monitoring and analytics capabilities are included in the disclosed embodiments, including state, process, event, error condition, and alert monitoring.

As used herein, the term “asset” refers to any component that is referenced in an asset identification hierarchy, such as shown in FIG. 1. Examples of assets include company, division, field, well, and field device.

As used herein, the term “field device” refers to a multi-sensor information system, and more particularly, to a tool for monitoring and managing individual measurements of subsurface chemical flows.

As used herein, the term “asset management” refers to building an asset hierarchy/model (e.g., who owns the asset, the location of the asset, etc.), building the metadata for monitoring the system, managing the configuration of the field device (e.g., state, network settings, etc.), and monitoring the field device. The disclosed embodiments construct and manage assets automatically so that the user is not burdened with setting up the configuration, which can be a complex and error prone process requiring much support. Moreover, measurement data without context can be useless; to avoid this, the interface automatically generates one or more asset hierarchies in the data historian to provide context to the data and to create unique identifications for the assets. In addition, the interface recognizes changes to the data source (i.e., changes are automatically reflected in the asset and the data historian).

As used herein, the term “data source” refers to any of a number of systems designed to provide streams of data. Examples of asset data are shown in Table 1 below:

TABLE 1
Examples of Asset Data

| Asset | Metadata |
|---|---|
| Company | Name |
| | Address |
| Division | Name |
| | Address |
| Field | Name |
| Well | Name |
| | Latitude |
| | Longitude |
| Device ID | ID |
| | IP address |
| | Port |
| | Connection status (online/offline) |
| | Packet period |
| | Last received packet |
| | System status |
| | Measurement template |

FIG. 1 illustrates an example asset hierarchy that uniquely identifies a data source according to this disclosure. Building an asset hierarchy such as shown in FIG. 1 allows security to be implemented at any level of the hierarchy, thereby securing and protecting the asset data accordingly. A set of access control information is associated with each asset, controlling the type of access allowed to a set of authorized users and groups. The security descriptor is created automatically when the interface creates the asset hierarchy in the data historian.

The measurement data also has a rich metadata model associated with it, as shown in Table 2 below. Table 2 shows a metadata model for a temperature measurement. Similar metadata models are used for other types of measurements, such as pressure or flow rate. Here, measurement can refer to output from a single sensor or transducer, or a calculated formula based on output from multiple sensors or transducers.

TABLE 2
Metadata model

| Measurement | Metadata |
|---|---|
| Temperature | Data type |
| | Default unit of measure |
| | Legal range - minimum value |
| | Legal range - maximum value |
| | Archive name |
| | Archive ID |
| | Description |
| | Filtering & compression criteria |

Embodiments of this disclosure can be configured to transmit and/or receive data using a variety of different communication protocols, including TCP/IP, UDP, USB, and PLC protocols. Data transferred between the interface and each data source can be transmitted via public IP addresses, which includes wireless connections operating with Advanced Encryption Standard (AES) 128 encryption. Some or all of the data sources can be connected to a cell modem, which is configured to broadcast messages to the specified IP address and port, where the interface resides and listens. Access to the physical field device is mediated by a packet channel with which the interface is configured, allowing the interface to be connected wirelessly or directly to the field device, e.g., via a USB serial cable.

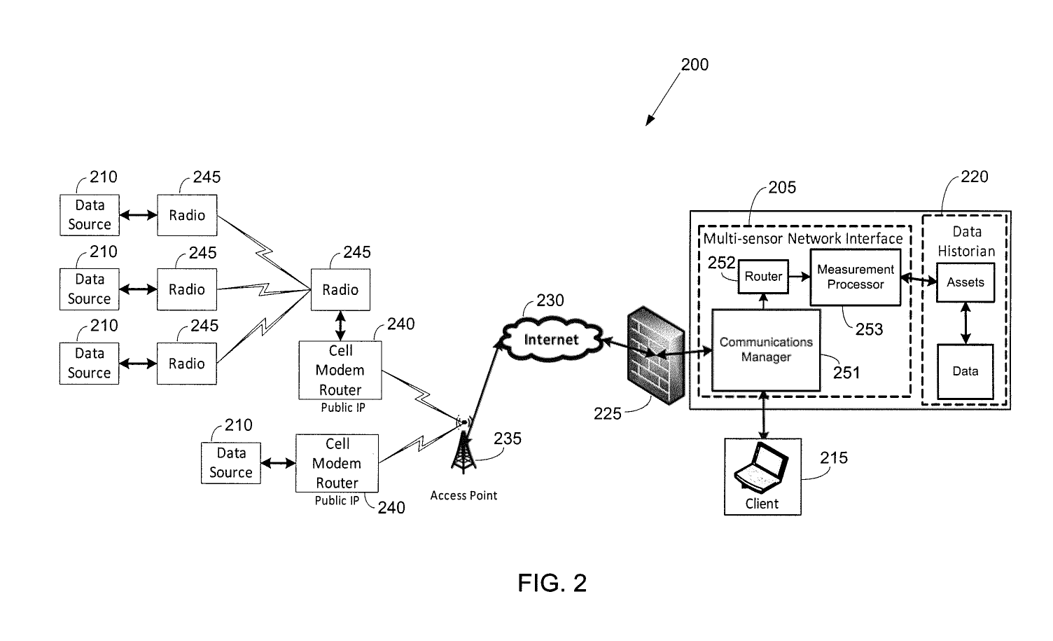

FIG. 2 illustrates an architecture diagram of an example system 200 that uses a multi-sensor network interface according to this disclosure. Those skilled in the art will recognize that, for simplicity and clarity, some features and components are not explicitly shown, including those illustrated in connection with later figures. Such features, including those illustrated in later figures, will be understood to be equally applicable to the system 200. It will be understood that all features illustrated in the figures may be employed in any of the embodiments described. Omission of a feature or component from a particular figure is for purposes of simplicity and clarity, and not meant to imply that the feature or component cannot be employed in the embodiments described in connection with that figure.

As shown in FIG. 2, the system 200 includes the multi-sensor network interface 205 (or simply, the interface 205), one or more data sources 210, a client application 215, and a data historian 220.

The interface 205 is capable of managing and monitoring multiple sensors associated with multiple data sources 210, and archiving the data that the sensors generate. The interface 205 provides mediation between the client application 215 and each data source 210, while processing and archiving heterogeneous measurement data that arrives in the form of unsolicited data packets or bulk data upload. The interface 205 includes a communications manager 251, a router 252, and a measurement processor 253. The communications manager 251 controls functions of the router 252, which interprets incoming and outgoing messages from/to the data sources 210 and processes the messages accordingly. The measurement processor 253 processes the measurement data from the data sources 210 before the data is provided to the data historian 220. The interface 205 is generally platform agnostic, and can be deployed on a variety of operating systems. The interface 205 can be configured to securely run within a web browser or as an installed desktop application. Security features, such as a user name and encrypted password, can be required for access to the interface 205.

The data historian 220 is configured to record and manage well production data using a time series database. In some embodiments, the data historian 220 and the interface 205 are part of a single computing device, such as a server. In such embodiments, the data historian 220 and the interface 205 communicate, e.g., over an internal bus. In other embodiments, the data historian 220 and the interface 205 reside on different computing devices. In such embodiments, the data historian 220 and the interface 205 can communicate over a network, such as a local area network (LAN).

In some embodiments, the interface 205 has no a priori knowledge of each data source 210. Each data source 210 notifies the interface 205 of its existence by sending an unsolicited commission notification packet to the interface 205. Using the information in the received commission notification packet, the interface 205 places the data source 210 into service in the system 200, and automatically provisions the sensors associated with the data source 210 for data collection. The commission notification packet contains the metadata that allows the interface 205 to treat the data source 210 as the system of record. Using the metadata in the commission notification packet, the interface 205 automatically creates the following:
Information of assets that uniquely identify the data source 210;
Data storage points in the data historian 220;
Metadata for monitoring the data source 210 for events, error conditions, alarms, and the like. For example, the interface 205 can perform analytics with respect to unresponsive systems, run-time clock errors, bad data errors, system status errors, and the like. Such errors can be preconfigured in the system 200 or could include user-configured error conditions.

Once the provisioning of each sensor associated with a data source 210 is complete, collection and analysis of useful sensor data can begin automatically within seconds.

The rich set of metadata enables the interface 205 to collect data from various assets, such as standalone wells and well battery operations (e.g., oil treatment facilities where the data source acquires data for more than one well). Furthermore, the metadata for each asset can be changed after the sensor or data source 210 has been put into service.

Each data source 210 represents a multi-sensor information system that samples its sensors (e.g., receives measurement information or data from each sensor) at a given rate. Each sample can contain one or multiple measurements (representing one or multiple data streams), and is referred to as a data block. As the system of record, the data source 210 is programmed to know its active configuration (i.e., the period at which to sample data), thereby allowing each field device (e.g., sensor) to autonomously sample and report data at unique intervals, obviating the need to preconfigure the interface 205 with this information, or have the interface 205 poll the field devices for the data. The configurability of the sample period is autonomous from the configuration of the interface 205; the client application 215 may update the sample period at any time via the interface's out-of-band channel that allows client programs to send operational commands, and configuration and firmware updates, to the data source 210.

The interface 205 communicates with each data source 210 over a network, such as the Internet 230 or another suitable data network. In some embodiments, for security purposes, a firewall 225 can be incorporated between the interface 205 and the Internet 230. The data sources 210 may connect to the Internet 230 over one or more wireless IP networks, which may include one or more access points 235, one or more cell modem routers 240, and one or more radios 245. As shown in FIG. 2, multiple levels of range-extending radios 245 can be used to relay a signal cell modem router 240 to a data source 210, or vice versa. In addition, information from multiple data sources 210 can be multiplexed via a single radio 245 to a single cell modem router 240.

Due to communications bandwidth requirements and data density, it is typically advantageous to send data in amounts larger than single blocks. Consequently, data sources 210 collect a number of data blocks and place them in a single packet. In effect, the data source 210 optimizes the amount of data versus packet size by collecting the maximum number of samples that can be fit in the allotted packet length, to form a contiguous data packet.

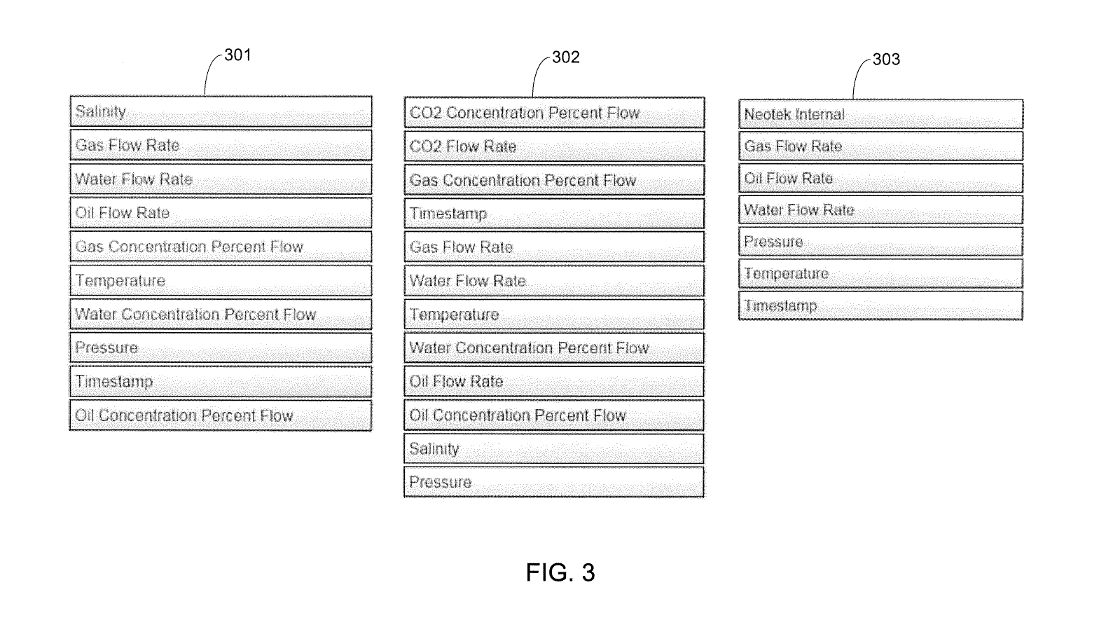

Each data block contains a predetermined number of variables corresponding to different measurements/data streams. The variables, their data type, and the order in which they appear in each data block are defined in a measurement template (e.g., one of the measurement templates 301-303 of FIG. 3, described below) that is associated with the data source 210 sending the message. To do this, the following calculation can be used to determine the number of blocks per packet:

Blocks Per Packet=Data Area/Block Size

where:
Data Area is the total number of bytes in each packet that can hold sample data bytes; and Block Size is the total number of bytes dictated by the size of all variables defined in the measurement template being used by the data source 210.

The data source 210 sends unsolicited message packets to the interface 205, where a message packet contains a block count specifying the number of data blocks in the packet, and a data block is comprised of one or more contiguous measurement (scalar) values. The packet period, computed by the data source 210, is the number of seconds between unsolicited message packets. The combination of the sample period, data area, and number of bytes per data block dictate the packet period.

When the interface 205 receives a message packet from a data source 210, the interface 205 employs the measurement template associated with the data source 210 to decompose the transmitted heterogeneous data into one or more data blocks, parses and decodes the data block(s), and formats the data correctly into multiple data storage locations in the data historian 220, such that each component included in the data payload (other than the timestamp) corresponds to a unique storage location in the data historian 220. The interface 205 then assigns the timestamp to each measurement value, applies a method of filtering the data based on the measurement template, and then—if it passes the filtering criteria—passes the value to the data historian 220. The measurement template provides the ability to filter out data that users do not want to collect from a specific asset type.

Unsolicited messages received by the interface 205 are acknowledged. Upon receipt of a message packet from a data source 210, the interface 205 checks the entire packet via a cyclic redundancy check (CRC) comparison. If the packet is good, the interface 205 responds to the sending data source 210 with an ACK (acknowledged) protocol message; otherwise the interface 205 responds with a NAK (not acknowledged) protocol message. Depending on the communications protocol, if the data source 210 does not receive an ACK, then the data source 210 may not send the next message packet.

In the event the interface 205 does not receive data from a data source 210 within the calculated packet period, the interface 205 executes a timeout event, whereby it sends NAK (not acknowledged) protocol messages to the data source 210 at regular intervals until the data source 210 responds by retransmitting its last sent message packet.

The interface 205 supports multiple measurement templates that enable the variety of heterogeneous data types to vary from field device to field device. Measurement templates are configurable such that:
New templates may be added to the interface 205;
Existing templates may be dynamically modified at run-time;
Assigned templates to specific data sources 210 may be changed;
Existing templates may be deleted, provided no data source currently employs the template.

Although FIG. 2 illustrates one example of a system 200, various changes can be made to FIG. 2. For example, FIG. 2 is simply meant to illustrate possible components in one specific implementation. Each of the components shown in FIG. 2 could be implemented in other ways. Moreover, the system 200 could include more, fewer, or different components than those shown.

FIG. 3 illustrates three example measurement templates 301-303 that may be used by one or more of the data sources 210 and the interface 205 according to this disclosure. When it is commissioned, each data source 210 is assigned a measurement template, which specifies the measurements to sample, their data type, a timestamp, and the order in which they appear in each data block. Measurement templates enable the interface 205 to parse the data block. The data source 210 generates the timestamp, which the interface 205 applies to each measurement. If a measurement template is modified, the interface 205 is responsible for notifying each affected data source 210 of the new template assigned to it.

In the event that communication with the interface 205 is unavailable (e.g., the interface 205 times out because of a lack of expected data or a radio communication link fails), a data source 210 may be offline for a substantial period of time. Each data source 210 is capable of buffering its originating data traffic for a period of time (e.g., up to 72 hours) when no communication link for exfiltration is available. As a result, there could be a substantial amount of buffered data such that it would be impractical to attempt to transmit the data to the interface 205 once communication is restored. In this scenario, the data is capable of being harvested locally from the data source 210 (e.g., by downloading the data to a computer file or disk file), and then the resulting file uploaded to the interface 205, which parses the file and data contained within, in the same fashion as it would parse the data if the data had been sent over the data network. The file header contains the data source's active configuration translated into the corresponding measurement template, which instructs the interface 205 how to parse the data blocks. This may be necessary since the underlying measurement template may have changed between the time the data was captured by the data source 210 and the time it is uploaded to the interface 205.

While a message packet contains one or more data blocks, it contains only one System Status variable, which conveys the current system status of the associated field device. The interface 205 inspects and monitors this bit-wise status word, allowing the interface 205 to generate alerts and notifications based on device events.

Analytics software programmed in the interface 205 enable the interface 205 to collect event data (e.g., errors, alarms, status messages, and the like), monitor these events, and detect when a data source 210 has become unresponsive, sent bad data, or encountered hardware or operational failures. Upon detection of one of these events, the interface 205 can generate corresponding alerts, thereby reducing unit downtime and equipment damage, and increasing safety.

The interface 205 provides robust, reliable data collection; the interface 205 implements buffering to preserve the data if the connection between the interface 205 and the data historian 220 is lost. When the connection is restored, the buffered data is sent to the data historian 220.

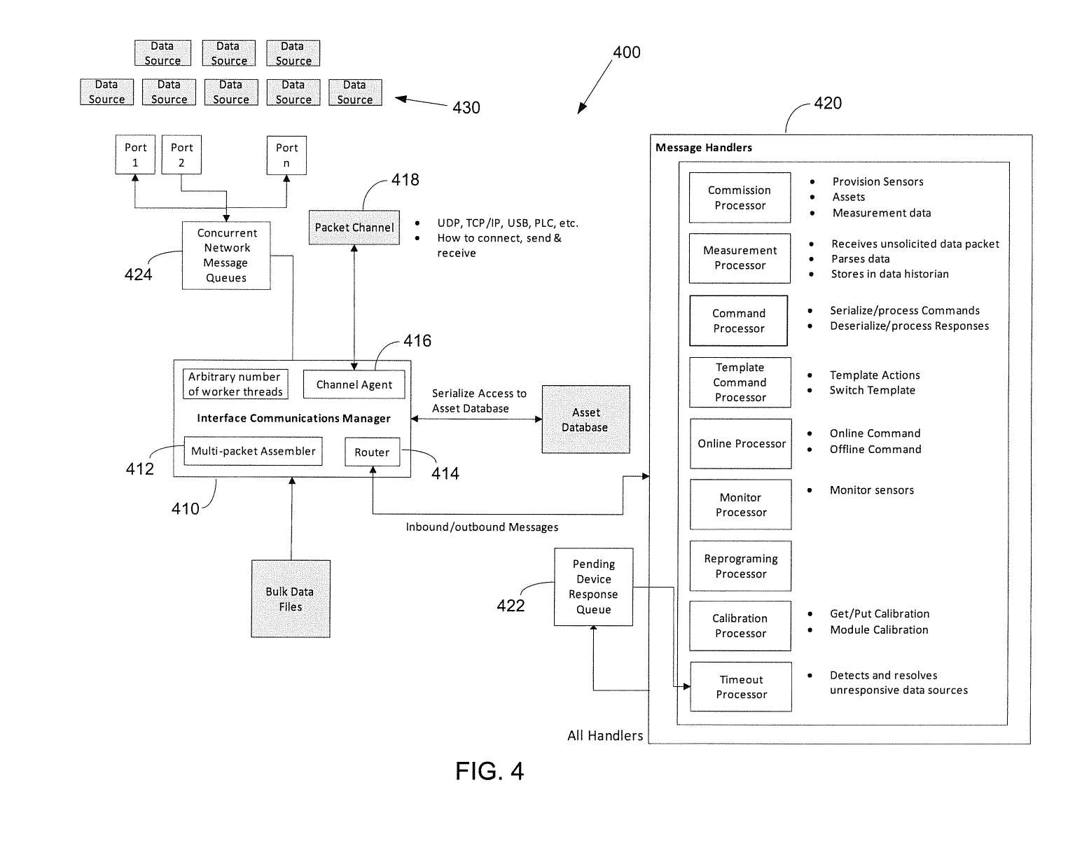

Embodiments of this disclosure provide an out-of-band channel that allows the client application 215 to send operational commands and configuration and filmware updates to one or more of the data sources 210. The out-of-band channel is used for transmission of system control information. The out-of-band channel is separate from the main data stream, which is used for transmission of sensor or transducer information. In some embodiments, the out-of-band channel and the main data stream use the same communication path. In other embodiments, the out-of-band channel and the main data stream can utilize different communication paths. In the out-of-band channel, the client application 215 sends logical commands (e.g., commands expressed in the client domain) to the interface 205. The interface 205 translates these commands into either commands intended for the interface 205 or commands intended for the data source 210. If the intended destination is the data source 210, then the interface 205 serializes the device command into a byte stream, and sends the command to the field device, as described in greater detail with respect to FIG. 4.

FIG. 4 illustrates additional details of a multi-sensor network interface 400 according to this disclosure. The multi-sensor network interface 400 may represent (or be represented by) the interface 205 of FIG. 2. The multi-sensor network interface 400 may represent any other suitable multi-sensor network interface and be used in any other suitable system.

As shown in FIG. 4, the multi-sensor network interface 400 includes an interface communications manager 410 and a plurality of message handlers 420. The interface communications manager 410 includes a multi-packet assembler 412, a router 414, a channel agent 416, and a packet channel 418. The interface 400 is configured to communicate with one or more data sources 430 (which may represent the data sources 210 of FIG. 2).

The multi-packet assembler 412 combines multiple packets to create a single contiguous file. The multi-packet assembler 412 can also take a single contiguous file and decompose it into multiple packets for transmission. Thus, the multi-packet assembler 412 can process messages for delivery to the data sources 430 over the out-of-band channel.

The router 414 is an agent that interprets incoming and outgoing messages from/to the data sources 430 and is responsible for delivering a message to an appropriate message handler 420. As used herein, an agent is a software-configured component that exercises one or more independent threads of control within a given process, and a message is a bounded set of data that is exchanged between the interface 400 and one of the data sources 430.

The channel agent 416 acts as a proxy for employing the correct communications protocol to connect the out-of-band channel to the device. The channel agent 416 manages the functions of the packet channel 418. Access to each data source 430 is mediated by the packet channel 418.

Each message handler 420 is an agent that receives a message via the out-of-band channel and processes the message. The message handlers 420 operate in conjunction with a pending device response queue 422. The pending device response queue 422 is a First-In-First-Out (FIFO) container that contains response proxies generated by the message handlers 420. This allows the interface 400 to know which commands and directives it is waiting for responses from the data sources 210. The concurrent network message queues 424 provide the ability to have multiple sets of incoming and outgoing messages over different hardware ports, thus providing extensibility of the system capabilities.

Although FIG. 4 illustrates one example of a multi-sensor network interface 400, various changes can be made to FIG. 4. For example, FIG. 4 is simply meant to illustrate possible components in one specific implementation. Each of the components shown in FIG. 4 could be implemented in other ways. Moreover, the interface 400 could include more, fewer, or different components than those shown.

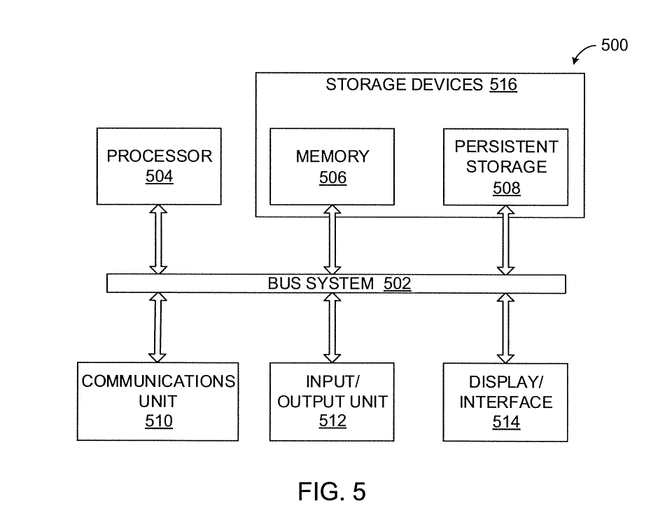

FIG. 5 illustrates an example computing device 500 for use in the system 200 according to this disclosure. For example, the computing device 500 can represent all or portions of any of the components 205-220 or the interface 400. In this example, the computing device 500 includes a bus system 502. The bus system 502 supports communication between a processing device 504, a memory 506, a persistent storage 508, a communications unit 510, an input/output (I/O) unit 512, and a display or display interface 514. Any suitable bus system(s) 502 can also be used here.

The processing device 504 processes software/firmware instructions, such as instructions loaded into the memory 506. The processing device 504 can include a single processor, multiple processors, one or more multi-processor cores, or other type(s) of processor(s) depending on the particular implementation. As an example, the processing device 504 is implemented using a number of heterogeneous processor systems in which a main processor is present with secondary processors on a single chip. As another example, the processing device 504 is a symmetric multi-processor system containing multiple processors of a same or similar type. Any suitable processing device(s) can be used.

The memory 506 and the persistent storage 508 are examples of storage devices 516. A storage device is any piece of hardware capable of storing information, such as data, program code, or other suitable information on a temporary or permanent basis. The memory 506 can be a random access memory or other volatile or non-volatile storage device(s). The persistent storage 508 contains one or more components or devices, such as a hard drive, flash memory, optical disc, or other persistent storage device(s). A storage device can be fixed or removable, such as when a removable hard drive or USB thumb drive is used.

The communications unit 510 provides for communications with other systems or devices. For example, the communications unit 510 can include a network interface card or a wireless transceiver. The communications unit 510 can provide communications through physical or wireless communications links.

The I/O unit 512 allows for input and output of data using other components connected to or integrated within the computing device 500. For example, the I/O unit 512 provides a connection for user input through a keyboard, a mouse, a microphone, or another input device. The I/O unit 512 also sends output to a display, printer, speaker, or other output device. The I/O unit 512 alternatively includes a keyboard, a mouse, a speaker, a microphone, or another input or output device(s). If the computing device 500 includes a display 514, the display or display interface 514 provides a mechanism to visually present information to a user. In some user devices, the display is represented as a touchscreen.

Program code for an operating system, applications, or other programs is located in the storage devices 516, which are in communication with the processing device 504 through the bus system 502. Instructions forming the programs are loaded into the memory 506 for processing by the processing device 504.

Although FIG. 5 illustrates one example of a computing device 500 that is used in the system 200, various changes can be made to FIG. 5. For example, FIG. 5 is simply meant to illustrate possible components in one specific implementation. Each of the components 205-220, 400 could be implemented in other ways, such as other ways that incorporate one or more processing devices, one or more memory devices storing data and instructions that are used, generated, or collected by the processing device(s), and one or more interfaces for communicating over a network.

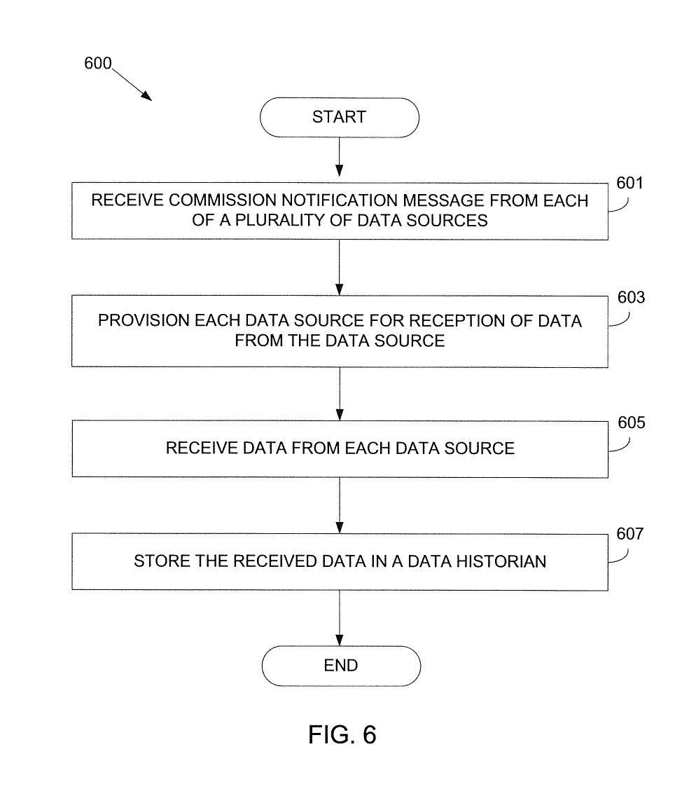

FIG. 6 illustrates an example method for a multi-sensor network interface according to this disclosure. For ease of explanation, the method 600 is described as being performed using the interface 205 of FIG. 2. However, the method 600 could be used with any suitable device or system.

At step 601, the interface 205 receives a commission notification message from each of multiple data sources associated with one or more sensors. This may include, for example, the interface 205 receiving an unsolicited commission notification packet from multiple ones of the data sources 210 over a network connection. The commission notification packet includes information that identifies the packet itself and identifies the asset(s) associated with the one or more sensors (e.g., what company owns the asset, what division it is in, what field it is in, what the well name is, etc.). The asset information may be in the form of an asset hierarchy.

At step 603, the interface 205 provisions each data source 210 for reception of data from the data source. This may include, for example, the interface 205 identifying a measurement template associated each the data source 210, placing the device in service, and creating one or more data streams for recording and collecting measurements from the sensors. The identified measurement template enables the data collection from the sensors associated with each data source 210.

At step 605, the interface 205 receives data from each data source 210. This may include, for example, each data source 210 autonomously pushing (i.e., sending the data without a request from the interface 205) measurement data from the sensors. The measurement data may be transmitted by each data source and received at the interface 205 at different rates. The measurement data per data source is heterogeneous data. Thus, when the data sources identify themselves to the interface 205 and the interface 205 provisions each data source, that data source becomes the data source of record for the information received from that data source.

At step 607, the interface 205 stores the received data in a data historian. This may include, for example, the interface 205 parsing each received data block using the measurement template associated with the data source to extract the received data, and then storing the received data in the data historian.

Although FIG. 6 illustrates one example of a method 600 for a multi-sensor network interface, various changes may be made to FIG. 6. For example, while shown as a series of steps, various steps shown in FIG. 6 could overlap, occur in parallel, occur in a different order, or occur multiple times. Moreover, some steps could be combined or removed and additional steps could be added according to particular needs.

As described herein, the embodiments of this disclosure include a number of advantageous features, which may include one, some, or all of the following:
Automatic provisioning of data sources for data collection.
   No need to preconfigure the interface with any knowledge of devices in the field.
   The provisioning process can take just a few seconds for users to be able to effectively analyze useful data versus what currently takes minutes or hours with other systems.
Automatic discovery of assets and measurement data for each field device.
Automatic creation of assets that uniquely identify the data source (e.g., company, division, field, well, unique ID).
   Rich metadata model for both assets and measurement data.
Automatic creation of metadata for monitoring the system for events, error conditions, and alarms.
   Flexibility—the metadata for each asset can be changed after the field device has been put into service.
   The rich set of metadata enables the interface to collect data from various assets, such as standalone wells and well battery operations (e.g., oil treatment facilities where the data source acquires data for more than one well).
Template driven treatment of the data source as the system of record.
Receiving geographically diverse data in an asset-centric manner, and storing time series data in a data historian, where the variety of heterogeneous data types can vary from device to device, as can the rate at which the data source sends the data (i.e., the sample period is highly configurable per device).
Receiving and parsing a network message packet containing aggregate data based on assets, not individual data streams; each packet can contain multiple, contiguous data blocks, and each data block can correspond to a single sample containing multiple data points, treated as a single entity of contiguous data.
Sending and receiving multi-packet messages, where the packets are disassembled from and assembled into contiguous data representing files.
Receiving and parsing a file containing bulk data from the data source.
An out-of-band channel that allows client programs to send operational commands and configuration and firmware updates to the data source.
Built-in analytics that enable the interface to collect event data types, monitor these events, and detect when a data source has become unresponsive, sent bad data, or encountered hardware or operational failures, and generate corresponding alerts, thereby reducing unit downtime and equipment damage, and increasing safety.
Configurable to run within a web browser or as an installed desktop application, with built-in security, including use of a username and encrypted password.
Simple, minimal configuration.
Secure data.
Higher speed for collecting data.
Buffering of data (robust, reliable data collection).

Some or all of these features can be achieved in the disclosed embodiments without human intervention.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit” and “receive,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method performed by at least one processing device, the method comprising:
receiving a commission notification message from each of a plurality of data sources, each data source associated with at least one sensor, wherein each data source is unknown to the at least one processing device before receipt of the commission notification message from the each data source;
in response to receiving the commission notification message from each data source, provisioning each data source for reception of data from the data source;
receiving data from each data source; and
storing the received data in a data historian,
wherein provisioning each data source comprises associating the data source with a measurement template selected from a plurality of different measurement templates, each of the measurement templates comprising (i) a list of measurements to sample in the received data from the data source and (ii) a data type associated with each of the measurements.,
wherein the received data from a first one of the data sources includes at least one different data type than the received data from a second one of the data sources.

2. The method of claim 1, wherein the received data from the first data source is received at a different rate than the received data from the second data source.

3. (canceled)

4. The method of claim 1, wherein the data from each data source is received in one or more data blocks, wherein the measurement template associated with the data source indicates an arrangement of the data in each of the one or more data blocks.

5. The method of claim 4, further comprising:
parsing each of the one or more data blocks using the measurement template associated with the data source to extract the received data before storing the received data.

6. The method of claim 1, wherein the commission notification message comprises metadata associated with properties of the at least one sensor.

7. The method of claim 1, wherein the first data source and the second data source are associated with different measurement templates, different data sampling rates, and different data types.

8. The method of claim 1, wherein each of the data sources is associated with an oil or gas well and the received data comprises chemical measurement data.

9. The method of claim 1, wherein:
the at least one sensor associated with each data source comprises a plurality of sensors, and
each of the data sources comprises a multi-sensor information system configured to receive measurement information from each of the plurality of sensors at a predetermined rate.

10. The method of claim 1, further comprising:
establishing an out-of-band channel configured to transmit operational commands to each of the data sources.

11. A multi-sensor network interface comprising:
at least one processor configured to:
receive a commission notification message from each of a plurality of data sources, each data source associated with at least one sensor, wherein each data source is unknown to the multi-sensor network interface before receipt of the commission notification message from the each data source;
in response to receiving the commission notification message from each data source, provision each data source for reception of data from the data source;
receive data from each data source; and
store the received data in a data historian,
wherein to provision each data source, the at least one processor is configured to associate the data source with a measurement template selected from a plurality of different measurement templates, each of the measurement templates comprising (i) a list of measurements to sample in the received data from the data source and (ii) a data type associated with each of the measurements,
wherein the received data from a first one of the data sources includes at least one different data type than the received data from a second one of the data sources.

12. The multi-sensor network interface of claim 11, wherein the received data from the first data source is received at a different rate than the received data from the second data source.

13. (canceled)

14. The multi-sensor network interface of claim 11, wherein the at least one processor receives the data from each data source in one or more data blocks, wherein the measurement template associated with the data source indicates an arrangement of the data in each of the one or more data blocks.

15. The multi-sensor network interface of claim 14, wherein the at least one processor is further configured to parse each of the one or more data blocks using the measurement template associated with the data source to extract the received data before storing the received data.

16. The multi-sensor network interface of claim 11, wherein the commission notification message comprises metadata associated with properties of the at least one sensor.

17. The multi-sensor network interface of claim 11, wherein the first data source and the second data source are associated with different measurement templates, different data sampling rates, and different data types.

18. The multi-sensor network interface of claim 11, wherein each of the data sources is associated with an oil or gas well and the received data comprises chemical measurement data.

19. The multi-sensor network interface of claim 11, wherein the at least one sensor associated with each data source comprises a plurality of sensors, and each of the data sources comprises a multi-sensor information system configured to receive measurement information from each of the plurality of sensors at a predetermined rate.

20. The multi-sensor network interface of claim 11, wherein the at least one processor is further configured to establish an out-of-band channel configured to transmit operational commands to each of the data sources.

21. The multi-sensor network interface of claim 11, wherein each of the measurement templates further comprises an order in which the measurements to sample appear in the received data.

22. The method of claim 1, wherein each of the measurement templates further comprises an order in which the measurements to sample appear in the received data.
